(19) United States
(12) Patent Application Publication
(10) Pub. No.: US 2026/0193895 A1
(43) Pub. Date: Jul. 9, 2026

(54) EQUIPMENT SECURITY ENCLOSURE AND METHOD OF MAKING AND USING SAME

(71) Applicant: David L. Boyce, Damascus, PA (US)

(72) Inventor: David L. Boyce, Damascus, PA (US)

(21) Appl. No.: 19/440,938

(22) Filed: Jan. 6, 2026

Related U.S. Application Data
(60) Provisional application No. 63/742,786, filed on Jan. 7, 2025.

(51) Int. Cl. E04H 1/12; E05B 15/10; E05D 11/00

(52) U.S. Cl. CPC E04H 1/1205; E05B 15/108; E05D 11/0054

(57) ABSTRACT

Systems, methods, and other embodiments for security enclosures for valuable equipment such as automatic teller machines (ATMs) or the like. The security enclosure is constructed as a modular structural enclosure that is capable of receiving a typical decorative branding cover while creating an unexpected barrier to an intruder or other nefarious actors. The branding cover is the only thing covering the equipment. Also, the security enclosure is constructed such that all of the mechanical attachments are completed from the inside of the enclosure and are, therefore, concealed. Finally, the valuable equipment located within the security enclosure is cradled inside of the security enclosure by support members in order to prevent the equipment from being damaged if the equipment security enclosure is knocked over by the intruder or other nefarious actors.

### CROSS REFERENCE TO RELATED APPLICATION

This application claims benefit of U.S. Patent Application 63/742,786, filed on Jan. 7, 2025, the disclosure of which is hereby incorporated by reference in its entirety to provide continuity of disclosure to the extent such a disclosure is not inconsistent with the disclosure herein.

### FIELD OF THE INVENTION

The present invention relates to an equipment security enclosure. In particular, the invention relates to security enclosures for valuable equipment such as automatic teller machines (ATMs) or the like. The security enclosure is constructed as a modular structural enclosure that is capable of receiving a typical decorative branding cover while creating an unexpected barrier to an intruder or other nefarious actors. The branding cover is the only thing covering the equipment. Also, the security enclosure is constructed such that all of the mechanical attachments are completed from the inside of the enclosure and are, therefore, concealed. Finally, the valuable equipment located within the security enclosure is cradled inside of the security enclosure by support members in order to prevent the equipment from being damaged if the equipment security enclosure is knocked over by the intruder or other nefarious actors.

### BACKGROUND OF THE INVENTION

Due to the changing times for financial and banking institutions, automatic teller machines (ATMs) have become ubiquitous so that customers can access their financial accounts almost anywhere. Due to this fact, criminals have started to hijack or otherwise forcibly remove ATMs from their locations in order to remove the money stored in the ATMs. Typically, an ATM contains tens of thousands of dollars in order to properly service the customers that will possibly use the ATM. Furthermore, the cost of an ATM can be in excess of $60,000. Therefore, the theft of an ATM can represent a loss of over $100,000 to the bank or financial institution that is operating the ATM.

It is also known that criminals are able to hijack or otherwise remove the ATM from its location in less than 5 minutes. The criminals have been known to use heavy duty equipment such as hydraulic rescue tools, commonly referred to as the “jaws of life”, in order to quickly pry open the ATM enclosure and quickly and easily remove the ATM from its enclosure and quickly and easily remove the money from the ATM.

Typically, it takes a first responder (i.e., police) 15-30 minutes or more to respond to the scene of a crime. Since criminals are currently able to hijack or otherwise remove the ATM from a decorative/branding enclosure in less than 5 minutes, the current decorative/branding enclosures for ATMs are not constructed to, at least, increase the amount of time that the criminals need in order to remove the ATM from the decorative/branding enclosure. Therefore, it would be desired that if an equipment security enclosure is not able to prevent the criminals from removing the ATM from the security enclosure, the equipment security enclosure should be constructed so that the criminals need at least 15-30 minutes or not at all in order to remove the ATM from its equipment security enclosure. This additional amount of time should then be enough time for first responders to arrive at the crime scene in order to prevent the criminals from hijacking or otherwise removing the ATM. Furthermore, it would be desired to prevent the ATM from being damaged if the equipment security enclosure is knocked over by the criminals while the criminals are trying to hijack or otherwise remove the ATM.

This invention's purpose is to fulfill these and other needs in the equipment security enclosure art in a manner more apparent to the skilled artisan once given the following disclosure.

The preferred equipment security enclosure, according to various embodiments of the present invention, offers the following advantages: ease of construction; a very heavy, final durable assembly; ease of shipment of the equipment security enclosure; modular construction of the equipment security enclosure; location of all mechanical attachments inside of the equipment security enclosure; equipment can be cradled within the equipment security enclosure to prevent damage to the equipment if the security enclosure is knocked over; reduced ability to easily remove the equipment from the equipment security enclosure; and reduced likelihood of the loss of the equipment. In many of the preferred embodiments, these advantages are optimized to the extent that is considerably higher than previously achieved in prior known equipment enclosures.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 is an isometric, top view of an equipment security enclosure system, constructed according to various embodiments of the present invention described herein.

FIG. 2 is an isometric, top view of the top/bottom plate assembly, constructed according to various embodiments of the present invention described herein.

FIG. 3 is a schematic, top view of the modular panel assembly, constructed according to various embodiments of the present invention described herein.

FIG. 4 is an isometric, top view of the panel assembly and post assembly connection, constructed according to various embodiments of the present invention described herein.

FIG. 5 is an isometric, top view of the post assembly, constructed according to various embodiments of the present invention described herein.

FIG. 6 is an isometric, top view of the multi-point lock assembly, constructed according to various embodiments of the present invention described herein.

FIG. 7 is an isometric, top view of the hinge cover assembly, constructed according to various embodiments of the present invention described herein.

FIG. 8 is an isometric, top view of the concealed hinge assembly, constructed according to various embodiments of the present invention described herein.

FIG. 9 is an isometric, top view of a removable decorative enclosure for enclosing an equipment security enclosure system, constructed according to various embodiments of the present invention described herein.

FIG. 10 is an exploded view of the removable decorative enclosure for enclosing the equipment security enclosure system, constructed according to various embodiments of the present invention described herein.

FIG. 11 is an isometric, top view of one set of adjacent sections of the removable decorative enclosure for enclosing the equipment security enclosure system prior to being connected together, constructed according to various embodiments of the present invention described herein.

FIG. 12 is an isometric, top view of one set of adjacent sections of the removable decorative enclosure for enclosing the equipment security enclosure system being connected together, constructed according to various embodiments of the present invention described herein.

FIG. 13 is an isometric, close-up view of a section of the removable decorative enclosure for enclosing the equipment security enclosure system, constructed according to various embodiments of the present invention described herein.

### DETAILED DESCRIPTION OF THE INVENTION

The terminology used herein is to describe particular embodiments only and is not intended to be limiting to the invention. As used herein, the term “and/or” includes any and all combinations of one or more of the associated listed items. As used herein, singular forms “a”, “an”, and “the” are intended to include the plural forms as well as the singular forms unless the context clearly indicates otherwise. It will be further understood that the terms “comprises” and/or “comprising,” when used in this specification, specify the presence of stated features, steps, operations, elements, and/or components but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefits, and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

A new and unique equipment security enclosure and methods for making and using are discussed herein. In the following description, for purposes of explanation, numerous specific details are set forth to provide a thorough understanding of the present invention. It will be evident, however, to one skilled in the art that the present invention may be practiced without these specific details.

The present disclosure is considered an exemplification of the invention and is not intended to limit the invention to the specific embodiments illustrated by the figures or description below.

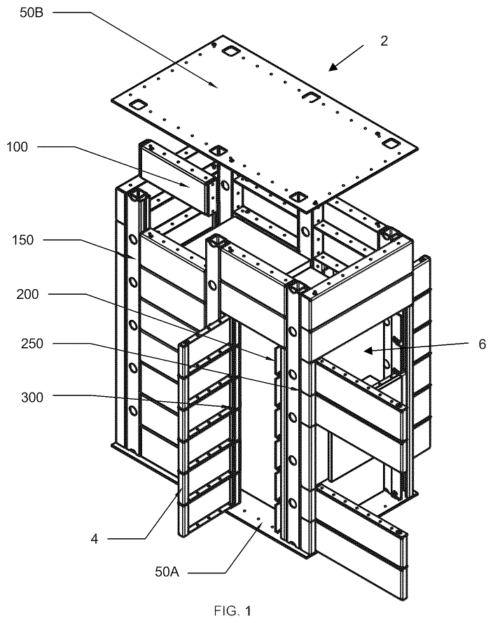

The present invention will now be described by referencing the appended figures representing preferred embodiments. FIGS. 1-8 are illustrations of an equipment security enclosure system for use with valuable equipment such as automatic teller machines (ATMs).

In particular, as shown in FIGS. 1-10, there is illustrated equipment security enclosure system 2 for use with valuable equipment such as automated teller machines (ATMs). In particular, the equipment security enclosure system 2 is constructed of any suitable, durable, high strength, rust resistant, UV resistant, heavyweight material such as a metallic material.

### Equipment Security Enclosure System 2

With respect to equipment security enclosure system 2, attention is directed to FIG. 1. As shown in FIG. 1, in one embodiment, equipment security enclosure system 2 includes, in part, top/bottom plate assemblies 50A/50B, modular panel assembly 100, post assembly 150, multi-point lock assembly 200, hinge cover assembly 250, and concealed hinge assembly 300. It is to be understood that the hinge assembly is continuous.

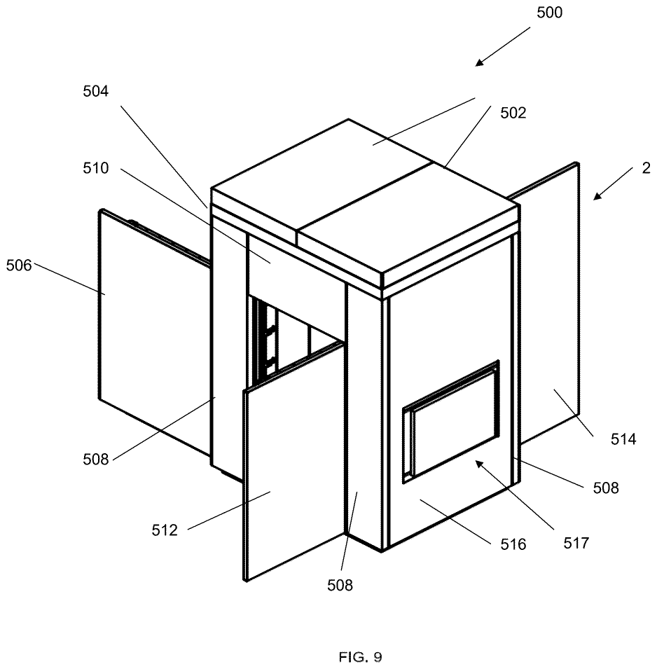

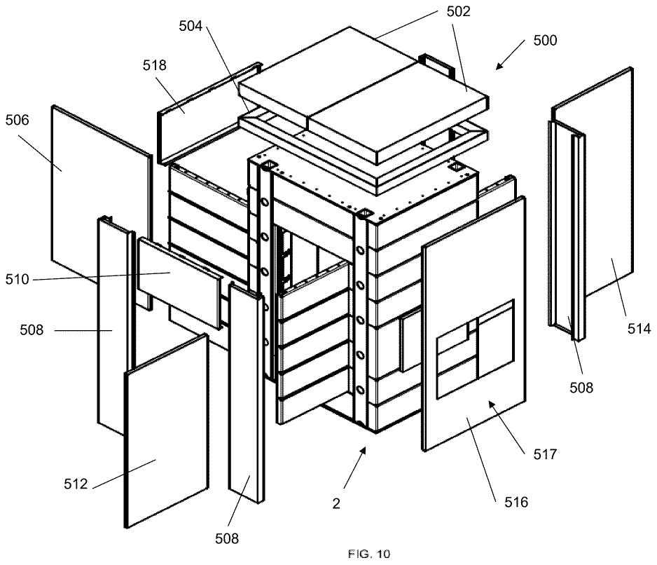

A unique aspect of the present invention is that the equipment security enclosure system 2 is constructed as a modular structural enclosure that is capable of receiving a unique, decorative branding cover 500 (FIGS. 9 and 10) while creating an unexpected barrier to an intruder or other nefarious actors. The branding cover 500 is the only thing covering the equipment. Also, the equipment security enclosure system 2 is constructed such that all of the mechanical attachments are completed from the inside of the equipment security enclosure system 2 and are, therefore, concealed. Finally, the equipment located within the equipment security enclosure system 2 is cradled inside of the equipment security enclosure system 2 by support members in order to prevent the equipment from being damaged if the equipment security enclosure system 2 is knocked over by the intruder to other nefarious actors.

### Top/Bottom Plate Assembly 50

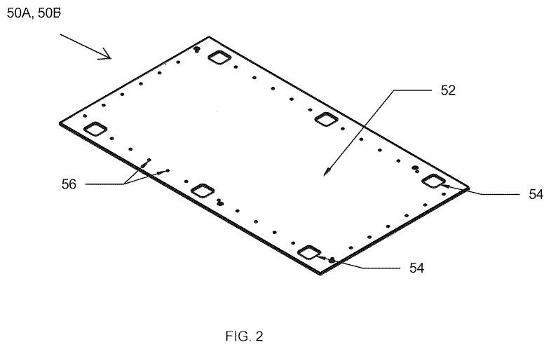

With respect to top/bottom plate assemblies 50A/50B, in one embodiment, as shown in FIG. 2, each top/bottom plate assembly 50A/50B includes, in part, plate 52, post openings 54, and modular panel assembly fastener opening 56. In one embodiment, the post openings 54 and the modular panel assembly fastener opening 56 are formed in the plate 52 by conventional techniques such as molding, forming, grinding, cutting or the like. It is to be understood that the thickness of plate 52 should be such that plate 52 is able to adequately retain the modular panel assembly 100, post assembly 150, multi-point lock assembly 200, hinge cover assembly 250, and concealed hinge assembly 300 securely in place.

A unique aspect of the present invention is that modular panel assembly fastener openings 56 are conventionally threaded. Also, all of the fasteners that are attached to the plate 52 are attached from the inside of the equipment security enclosure system 2. Finally, the post openings 54 are constructed to accommodate an alignment of the post assembly 150 and, if needed, an extension of the post assembly 150 into the ground or to an additional structure above the equipment security enclosure system 2.

### Modular Panel Assembly 100

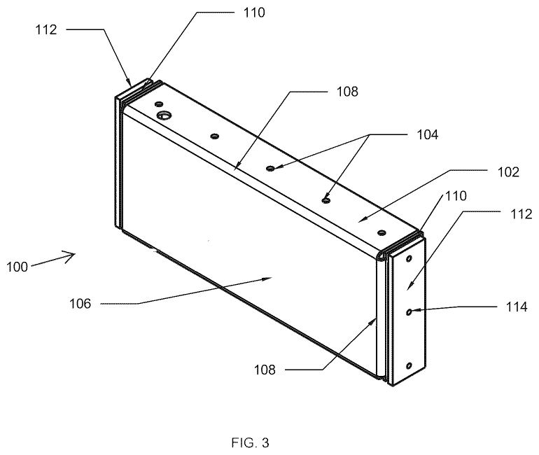

With respect to modular panel assembly 100, in one embodiment, as shown in FIG. 3, modular panel assembly 100 includes, in part, panel sides 102, fastener openings 104, panel front 106, panel radius 108, a plurality of panel side extensions 110 (wherein each of the plurality of panel side extensions 110 is connected to the each of the plurality of panel sides 102), a plurality of panel sides continuous attachment bars 112 (wherein each of the plurality of panel sides continuous attachment bars 112 are located adjacent to each of the plurality of panel side extensions 110), and panel side fasteners openings 114. In one embodiment, the fastener openings 104 and panel side fasteners openings 114 are formed by conventional techniques such as molding, forming, grinding, cutting or the like. It is to be understood that panel sides 102 and panel front 106 are formed from one-piece of material which includes a panel radius 108.

A unique aspect of the present invention is that each panel assembly 100 can be attached to another panel assembly 100 through the use of fastener openings 104. Also, the bottom level of panel assemblies 100 is attached to bottom plate assembly 50A through the use of fasteners (not shown) and modular panel assembly fastener opening 56. Also, the panel sides continuous attachment bar 112 are connected to the post assembly 150, as will be discussed in greater detail later. In this manner, the attachment of the panel assembly 100 to another panel assembly 100 and the attachment of the panel assembly 100 to post assembly 150 will create a blind and flush attachment between each of the panel assemblies 100 and the post assembly 150. Also, the fasteners used to connect the panel assemblies 100 to each other, connect a panel assembly 100 to the post assembly 150, and connect the panel assemblies 100 to the bottom plate assembly 50A are located on the interior of the panel assembly 100 so that the fasteners cannot be easily removed and the panel assemblies 100 cannot be easily pried apart due to rows of concealed fasteners. Finally, the panel assemblies 100, the post assembly 150, and the bottom plate assembly 50A are attached together so that they create a flush exterior surface that cannot be easily gripped by hydraulic rescue equipment.

Another unique aspect of the present invention is the use of the panel radius 108. In particular, the panel radius 108 is constructed on the panel assembly 100 in order to prevent a gripping of the equipment security enclosure system 2 by any equipment such as hydraulic rescue equipment.

Another unique aspect of the present invention is the use of horizontal folds (not shown) in the panel assembly 100. In particular, the horizontal folds are constructed to be able to engage the horizontal folds in the adjacent panel assembly 100 in order to create a structural rail (not shown).

A still another unique aspect of the present invention is the use of a thin metal panel (not shown) that can be added to the interior of the panel assembly 100. The metal panel can be used to create a space (not shown) between the front panel 106 and the metal panel. Additional reinforcement material (not shown) such as concrete can then be conventionally placed within the space.

Finally, another unique aspect of the present invention is the use of a combination of thick metal panel plate assemblies 50, panel assemblies 100, and post assemblies 150 along with hardened steel balls or tubes (not shown), and concrete to create an equipment security enclosure system 2 that makes it difficult to cut into. Also, if the criminals use metal cutting tools such metal cutting saws to cut into the equipment security enclosure system 2, these additional materials should potentially destroy the metal cutting blade when the cutting blade comes into contact with the concealed concrete and/or hardened steel balls.

### Post Assembly 150

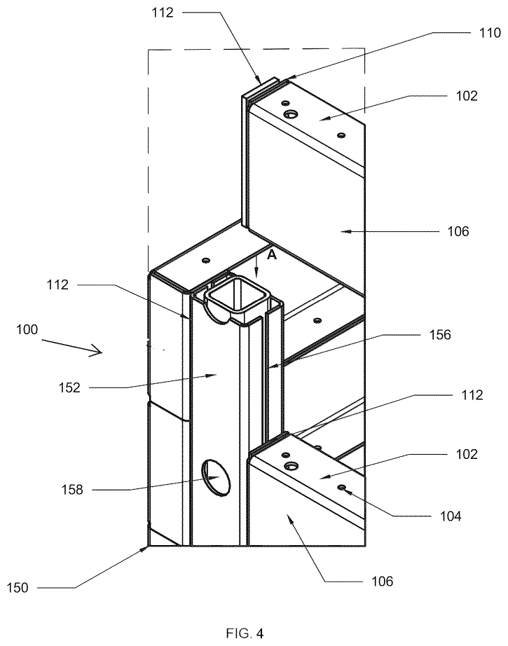

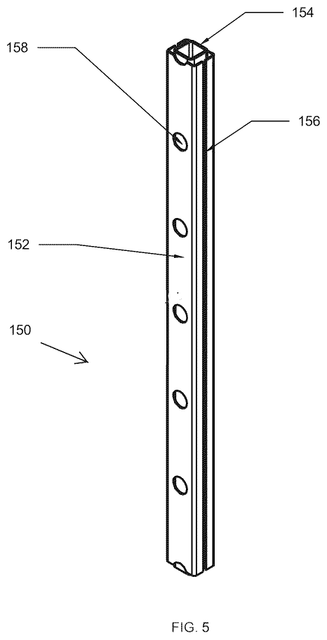

With respect to post assembly 150, in one embodiment, as shown in FIGS. 4 and 5, post assembly 150 includes, in part, post enclosure 152, interior post 154, post slot 156, and post openings 158. In one embodiment, the post slot 156 and post openings 158 are formed by conventional techniques such as molding, forming, grinding, cutting or the like. Also, it is to be understood that interior post 154 should be constructed so that is capable of being quickly and easily completely located within post assemblies 152.

A unique aspect of the present invention is the use of post slot 156. As will be discussed in greater detail later, post slot 156 is sized and shaped so as to be able to accommodate the side panels continuous attachment bar 112 of each panel assembly 100. In this manner, each panel assembly 100 is able to be quickly and easily attached to the post assembly 150 by sliding the panel assembly 100 along the direction of arrow A (FIG. 4) to create a blind and flush attachment to the post assembly 150.

Another unique aspect of the present invention is the option to fill the interior post 154 with hardened steel balls or concrete (not shown) in order to substantially limit the ability to cut through the post assembly 150.

A still another unique aspect of the present invention is that post assembly 150 could be extended below the plate assembly 50A and anchored into the ground or extended upwardly through the plate assembly 50B (FIG. 1) and anchored to a building structure.

As shown in FIG. 4, each panel assembly 100 is attached to the post assembly 150 through the use of the post slot 156 and the side panel continuous attachment bar 112. As will be discussed in greater detail later, conventional high strength fasteners (not shown) in conjunction with fastener openings 104 can be used to secure each panel assembly 100 to each other. In this manner, the attachment of the panel assemblies 100 to the post assembly 150 creates an intentionally flush exterior surface that should substantially prevent any mechanical equipment such as hydraulic rescue equipment from gripping the panel assemblies 100 and/or the post assemblies 150.

### Multi-Point Lock Assembly 200

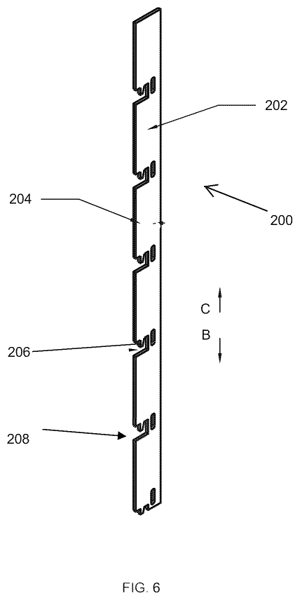

With respect to multi-point lock assembly 200, in one embodiment, as shown in FIG. 6, multi-point lock assembly 200 includes, in part, sliding bar 202, bar sections 204, interlocking teeth 206 (wherein each of the plurality of bar sections 204 includes at least one of the plurality of interlocking teeth 206), and bar openings 208 (, wherein at least one of the plurality of interlocking teeth 206 is located within each of the plurality of bar openings 208). In one embodiment, the interlocking teeth 206 and bar openings 208 are formed by conventional techniques such as molding, forming, grinding, cutting or the like.

A unique aspect of the present invention is that sliding bar 202 is constructed as a continuous bar with a sliding motion. Also, the sliding bar 202 includes at least one interlocking tooth 206 located within bar opening 208, wherein each interlocking tooth 206 is configured to interlock with an adjacent panel assembly 100. As will be discussed in greater detail later, once the sliding plate 202 is lowered in the direction of arrow B, an interlocking tooth 206 will interact with the adjacent panel assembly 100 by contacting a panel sides 102 in order to lock the equipment security enclosure system 2. Conversely, once the sliding plate 202 is raised in the direction of arrow C, an interlocking tooth 206 will disengage from the adjacent panel assembly 100 in order to unlock the equipment security enclosure system 2.

### Hinge Cover Assembly 250

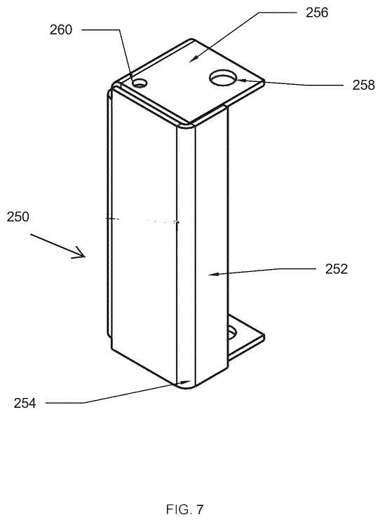

With respect to hinge cover assembly 250, in one embodiment, as shown in FIG. 7, hinge cover assembly 250 includes, in part, hinge cover 252, hinge cover radius 254, hinge cover plates 256, hinge opening 258, and threaded opening 260. In one embodiment, the hinge opening 258 and threaded opening 260 are formed by conventional techniques such as molding, forming, grinding, cutting or the like. It is to be understood that hinge cover 252 is constructed as a one-piece construction that includes hinge cover radius 254. It is also to be understood that the hinge cover radius 254 is similar in construction to panel radius 108 and hinge cover radius 254 is constructed on the hinge cover 252 in order to prevent a gripping of any equipment such as hydraulic rescue equipment.

A unique aspect of the hinge cover assembly 250 is that the hinge cover assembly 250 is constructed so that the hinge cover assembly 250 blends into the panel assemblies 100 and the post assemblies 150 in order to make it challenging for criminals to locate where any of the access points of the equipment security enclosure system 2 are located. Furthermore, dummy hinge cover assemblies (not shown) could be applied anywhere on the equipment security enclosure system 2 to further make it impossible to discover the location of the access points

Another unique aspect of the present invention is that hinge openings 258 are sized and shaped so as to be able to accommodate a hinge assembly 300 (wherein the hinge opening 258 is configured to retain the concealed hinge assembly 300). Also, threaded openings 260 can be used in conjunction with fasteners (not shown) to secure a hinge cover assembly 250 to another hinge cover assembly 250. Furthermore, the fasteners used to connect the hinge cover assemblies 250 together are located on the interior of the hinge cover assembly 250 so that the fasteners cannot be easily removed and the hinge cover assemblies 250 cannot be easily pried apart. Finally, the hinge cover assemblies 250 are attached together so that they create a flush exterior surface that cannot be easily gripped by hydraulic rescue equipment.

### Concealed Hinge Assembly 300

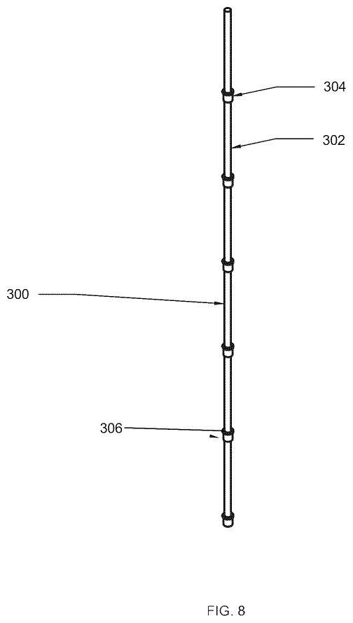

With respect to concealed hinge assembly 300, in one embodiment, as shown in FIG. 8, concealed hinge assembly 300 includes, in part, hinge section 302, hinge section connector 304, and hinge bearings 306 which are located on hinge section connector 304 and are configured to allow hinge section connector 304 to move or rotate within hinge bearing 306. It is to be understood that the number of hinge sections 302 can be varied depending upon the desired length of the concealed hinge assembly 300.

A unique aspect of the present invention is that the concealed hinge assembly 300 is concealed within the interior of the equipment security enclosure system 2 (through the use of hinge cover assemblies 250) in order to make it challenging for criminals to locate where the concealed hinge assembly 300 is located. Furthermore, dummy hinge covers (not shown) could be applied anywhere on the equipment security enclosure system 2 to further make it impossible to discover the location of the access points.

Another unique aspect of the present invention is that the concealed hinge assembly 300 engages the horizontal webs (not shown) of each of the panel assemblies 100 in order to provide structural support for the concealed hinge assembly 300.

A still another unique aspect of the present invention is that the concealed hinge assembly 300 is supported on the hinge cover assemblies 250 by the hinge bearings 306.

### Decorative Enclosure 500 for the Equipment Security Enclosure System 2

With respect to the decorative enclosure 500 for enclosing equipment security enclosure system 2, attention is directed to FIGS. 9-13. As shown in FIGS. 9 and 10, in one embodiment, enclosure 500 includes, in part, the following sections; upper panels 502, upper panel frame 504, rear door 506, door frame sides 508, side door frame top 510, side doors 512 and 514, front panel 516 having opening 517, and rear door frame top 518. Preferably, enclosure 500 is constructed of any suitable, durable, high strength, rust resistant, UV resistant, heavyweight material such as a metallic material.

A unique aspect of the present invention is that the sections of enclosure 500 are attached together to provide an enclosure that does not provide access outside of the enclosure 500 to the fasteners that are used connect the sections of the enclosure together 500. Also, the enclosure 500 does not provide any access points to prevent a gripping of any equipment such as hydraulic rescue equipment, as will be discussed in greater detail later.

Another unique aspect of the present invention is that the enclosure 500 is a removable decorative facade that can be utilized to cover the equipment security enclosure system 2. Secondly, the enclosure 500 is configured to conceal the equipment security enclosure system 2. Thirdly, the enclosure 500 is configured to be a sacrificial cover that can be replaced. In particular, if the enclosure 500 is damaged by criminals trying to break into the ATM, the enclosure 500 can easily be replaced. Fourthly, the enclosure 500 can include advertising or other similar branding on the outside of the enclosure 500. Finally, the enclosure 500 can be equipped with optional lighting (not shown).

### Constructing Equipment Security Enclosure System 2

With respect to constructing equipment security enclosure system 2 for use with valuable equipment such as automated teller machines (ATMs), attention is directed to FIGS. 1-8. As discussed earlier, post assemblies 150 are constructed as discussed earlier. It is to be understood that the length of the post assemblies 150 can be adjusted based upon the desired height of the equipment security enclosure system 2.

Once the post assemblies 150 are constructed, the post assemblies 150 are placed within the post openings 54 of bottom plate assembly 50A. As discussed earlier, the post assembly 150 could be extended below the plate assembly 50A and anchored into the ground or extended upwardly through the plate assembly 50B and anchored to a building structure.

After the post assemblies 150 are placed within the post openings 54, the number of panel assemblies 100 needs to be determined. It is to be understood that the size and shape of the equipment security enclosure system 2 will determine how many and what size modular panel assemblies 100 will be needed.

Once the number of panel assemblies 100 has been determined, the panel assemblies 100 are slid into the post slot 156 (FIGS. 1 and 4). The panel assemblies 100 are then attached to each other through the use of fasteners (not shown) attached to a continuous attachment bar and threaded fastener openings 104, as discussed earlier. Also, the panel assemblies 100 are attached to bottom plate assembly 50A through the use of fasteners (not shown) and threaded fastener openings 104 and modular panel assembly fastener openings 56. In this manner, the attachment of the panel assembly 100 to another panel assembly 100, the attachment of the panel assembly 100 to post assembly 150, and the attachment of the panel assemblies 100 to bottom plate assembly 50A will create a blind and flush attachment between each of the panel assemblies 100, the post assembly 150, and bottom plate assembly 50A. Also, the fasteners used to connect the panel assemblies 100 to each other, connect a panel assembly 100 to the post assembly 150, and connect the panel assemblies 100 to bottom plate assembly 50A are located on the interior of the panel assembly 100 so that the fasteners cannot be easily removed and the panel assemblies 100 cannot be easily pried apart by hydraulic rescue equipment.

Once the panel assemblies 100 have been secured to each other and the bottom plate assembly 50A, at least one panel assembly 100 is used to construct a door 4 (FIG. 1) on the equipment security enclosure system 2. If more than one panel assembly 100 is used for the door 4, these panel assemblies 100 are secured together, as discussed earlier.

After the panel assemblies 100 are secured together, the hinge cover assembly 250 is constructed to accommodate the concealed hinge assembly 300 that is used to secure the door 4. As discussed above, the concealed hinge assembly 300 is concealed within the interior of the equipment security enclosure system 2 (behind each of the hinge cover assemblies 250) in order to make it challenging for criminals to locate where the concealed hinge assembly 300 is located.

A unique aspect of the present invention is the use of hinge cover assembly 250. As discussed above, hinge cover assembly 250 is constructed so that the hinge cover assembly 250 blends into the panel assemblies 100 and the post assemblies 150 in order to make it challenging for criminals to locate where any of the access points of the equipment security enclosure system 2 are located.

Once the door 4 has been constructed, the multi-point lock assembly 200 is attached to the equipment security enclosure system 2. As discussed earlier, sliding bar 202 is constructed as a continuous bar with a sliding motion. Also, the sliding bar 202 includes at least one interlocking tooth 206, wherein each interlocking tooth 206 is configured to interlock with each panel assembly 100. As will be discussed in greater detail later, once the sliding plate 202 is lowered in the direction of arrow B, an interlocking tooth 206 will interact with the adjacent panel assembly 100 in order to lock the equipment security enclosure system 2. Conversely, once the sliding plate 202 is raised in the direction of arrow C, an interlocking tooth 206 will disengage from the adjacent panel assembly 100 in order to unlock the equipment security enclosure system 2.

After the multi-point lock assembly 200 has been installed, the top plate assembly 50B is located over the top section of panel assemblies 100 and post assemblies 150. The top plate assembly 50B is then secured to the top section of the panel assemblies 100 through the use of fasteners (not shown) and threaded fastener openings 104 and modular panel assembly fastener opening 56. In this manner, the attachment of the panel assembly 100 to another panel assembly 100, the attachment of the panel assembly 100 to post assembly 150, and the attachment of the upper level of panel assemblies 100 to top plate assembly 50B will create a blind and flush attachment between each of the panel assemblies 100, the post assembly 150, and the plate assemblies 50A/50B. Also, the fasteners used to connect the panel assemblies 100 to each other, connect a panel assembly 100 to the post assembly 150, and connect the panel assemblies 100 to the plate assemblies 50A/50B are located on the interior of the panel assembly 100 so that the fasteners cannot be easily removed and the panel assemblies 100 and the plate assemblies 50A/50B cannot be easily pried apart. Finally, the panel assemblies 100, the post assembly 150, and the plate assemblies 50A/50B are attached together so that they create a flush exterior surface that cannot be easily gripped by hydraulic rescue equipment.

### Constructing Decorative Enclosure 500

With respect to constructing decorative enclosure 500 for use with equipment security enclosure system 2, attention is directed to FIGS. 9-13. As discussed above, as shown in FIGS. 9 and 10, in one embodiment, enclosure 500 includes, in part, the following sections; upper panels 502, upper panel frame 504, rear door 506, door frame sides 508, side door frame top 510, side doors 512 and 514, front panel 516 having opening 517, and rear door frame top 518. Preferably, enclosure 500 is constructed of any suitable, durable, high strength, rust resistant, UV resistant, heavyweight material such as a metallic material.

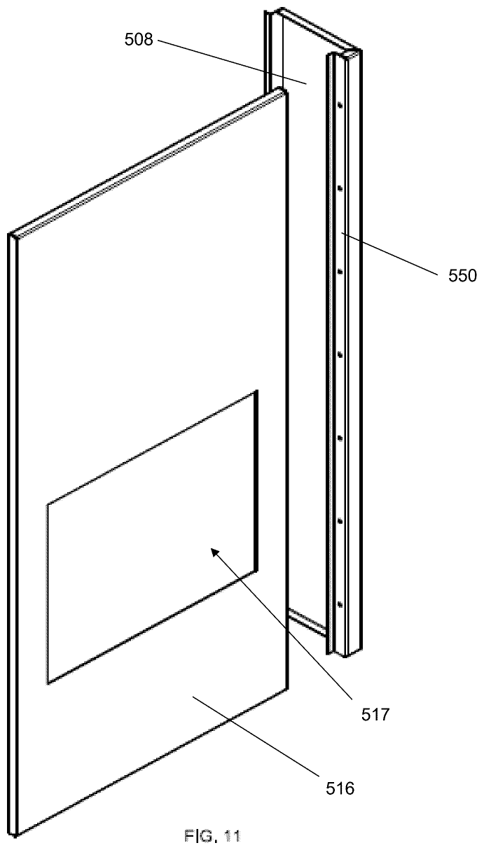

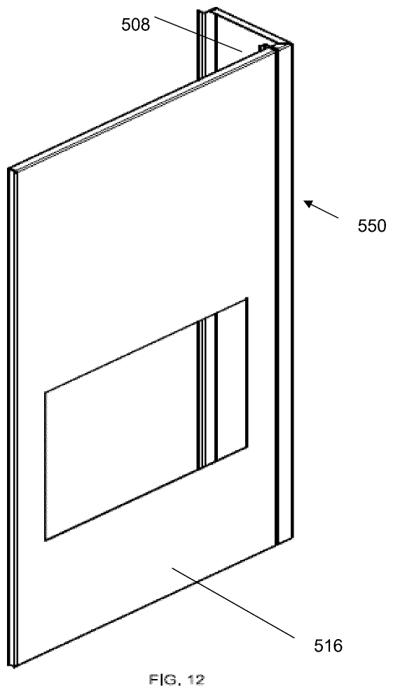

In order to construct decorative enclosures 500, attention is directed to FIGS. 11-13. As shown in FIG. 11, for simplicity's sake, assume that front panel 516 is going to be connected to one of the door frame sides 508. As shown in FIG. 12, assume that front panel 516 has been connected to one of the door frame sides 508.

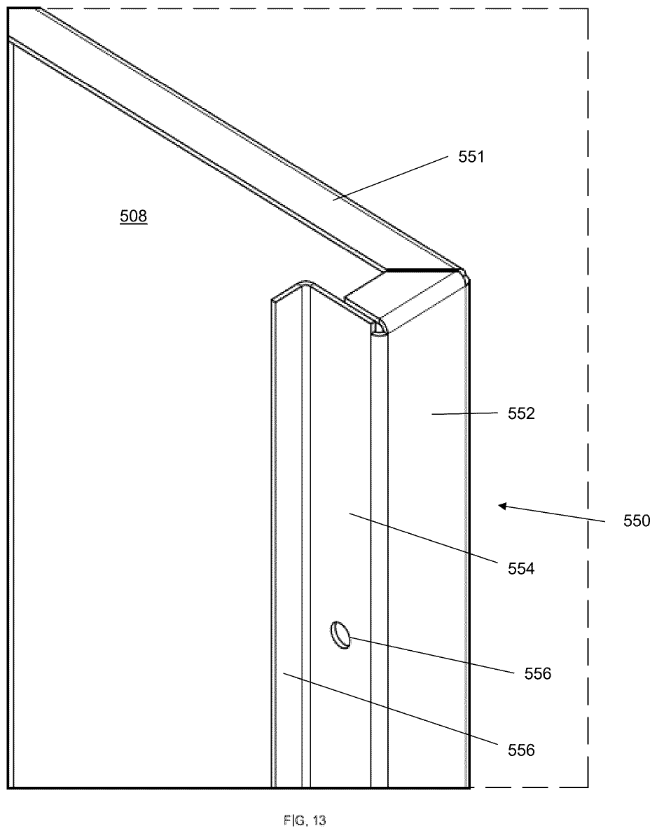

In order to connect front panel 516 to one of the door frame sides 508, as shown in FIG. 13, each of the sections of enclosure 500 is equipped with a frame assembly 550. In one embodiment, the frame assembly 550 includes, in part, a frame top 551, a frame side 552, a frame extension 554 having at least one opening 556, and a frame extension 556.

As shown in FIG. 12, in order to connect front panel 516 to one of the door frame sides 508, the front panel 516 is aligned with the one of the door frame sides 508 so that the top of the front panel 516 is level with the frame top 551, the side of the front panel 516 is in contact with the frame extension 554, and a portion of the back of the front panel 516 is in contact with the frame extension 558.

Once the front panel 516 has been aligned with the one of the door frame sides 508, a conventional fastener (not shown) can be located within the opening 556. The fastener can then be used to secure the side of the front panel 516 to the frame extension 554 and retain the portion of the back of the front panel 516 in contact with the frame extension 558. It is to be understood that there are a plurality of openings 556 located along the length of the frame extension 554, wherein these plurality of openings 556 are configured to assist in securing the various sections of the enclosure 500 together.

It is to be understood that each of the sections of the enclosure 500 is equipped with a similar frame assembly 550. In this manner, each of the sections of the enclosure 500 can be attached to adjacent sections of the enclosure 500 as shown in FIG. 9.

A unique aspect of the present invention is that the sections of enclosure 500 are attached together to provide an enclosure that does not provide access outside of the enclosure 500 to the fasteners that are used connect the sections of the enclosure 500 together. Also, the enclosure 500 does not provide any access points to prevent a gripping of any equipment such as hydraulic rescue equipment, as will be discussed in greater detail later.

Another unique aspect of the present invention is that the enclosure 500 is a removable decorative facade to that can be utilized to cover the equipment security enclosure system 2. Secondly, the enclosure 500 is configured to conceal the equipment security enclosure system 2. Thirdly, the enclosure 500 is configured to be a sacrificial covering that can be replaced. If the enclosure 500 is damaged by criminals trying to break into the ATM, the enclosure 500 can easily be replaced. Fourthly, the enclosure 500 can include advertising or other similar branding on the outside of the enclosure 500. Finally, the enclosure 500 can be equipped with optional lighting (not shown).

### Using Equipment Security Enclosure System 2

With respect to using the equipment security enclosure system 2 to protect valuable equipment such as automated teller machines (ATMs), attention is directed to FIGS. 1-13. In order to use equipment security enclosure system 2 to protect valuable equipment, the size and shape of the valuable equipment needs to be determined.

Assume that the valuable equipment is an ATM. Once the size and shape of the ATM has been determined, the equipment security enclosure system 2 is constructed as discussed above in a size and shape that will accommodate the size and shape of the ATM or other equipment.

After the equipment security enclosure system 2 has been constructed, the ATM (not shown) is located within the interior of the equipment security enclosure system 2. It is to be understood that the door 4 and the top plate assembly 50B of the equipment security enclosure system 2 may need to be removed so that the ATM can be easily located within the equipment security enclosure system 2. It is also to be understood that the equipment security enclosure system 2 can include an opening (or openings) 6 so that an ATM display (not shown) of other similar type of user interface can be made available for use by the customers.

Once the ATM has been located within the equipment security enclosure system 2, the door 4 and the top plate assembly 50B of the equipment security enclosure system 2 will be attached to the equipment security enclosure system 2, as discussed earlier, so that they create a flush exterior surface that cannot be easily gripped by hydraulic rescue equipment.

After the door 4 and the top plate assembly 50B of the equipment security enclosure system 2 are attached to the equipment security enclosure system 2, the decorative enclosure 500 can be constructed around the equipment security enclosure system 2 so that the enclosure 500 also creates a flush exterior surface that cannot be easily gripped by hydraulic rescue equipment.

While it has not been mentioned, one familiar with the art would realize that the device is not limited by the materials used to create each apparatus that comprises the invention. Any other material type can comprise some or all of the elements in constructing an equipment security enclosure system 2 to protect valuable equipment such as automatic teller machines (ATMs) in various embodiments of the present invention.

Although the present invention has been illustrated and described herein with reference to preferred embodiments and specific examples, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. An equipment security enclosure system, comprising:
a first plate assembly;
a plurality of post assemblies, wherein each of the plurality of post assemblies includes a first end and a second end, and wherein the first end of each of the plurality of post assemblies is connected to the first plate assembly;
a plurality of modular panel assemblies connected to the plurality of post assemblies with continuous attachment bars, and wherein a first portion of the plurality of the modular panel assemblies is connected to the first plate assembly;
a multi-point lock assembly connected to a second portion of the plurality of modular panel assemblies;
a hinge cover assembly connected to a third portion of the modular panel assemblies, wherein the hinge cover assembly is located a predetermined distance away from the multi-point lock assembly;
a concealed hinge assembly located within the hinge cover assembly; and
a second plate assembly connected to the second end of each of the plurality of post assemblies, and wherein a fourth portion of the plurality of the modular panel assemblies are connected to the second plate assembly.

2. The system, according to claim 1, wherein the system further comprises:
a decorative enclosure, wherein the decorative enclosure is configured to cover the equipment security enclosure system, wherein the decorative enclosure is configured to create a flush exterior surface that cannot be gripped by a hydraulic rescue equipment, and wherein the decorative enclosure comprises;
a plurality of upper panels,
an upper panel frame under the plurality of upper panels,
a rear door located adjacent to the upper panel frame,
a plurality of door frame sides located adjacent to the upper panel frame,
a side door frame top located adjacent to two of the plurality of door frame sides,
at least one side door located adjacent to the side door frame top;
a front panel having opening, wherein the front panel is located adjacent to the at least one side door, and
a rear door frame top located adjacent to the rear door.

3. The system, according to claim 1, wherein each of the plurality of post assemblies further comprises:
a post enclosure;
an interior post located within the post enclosure;
a post slot located along a first side of the post enclosure; and
a plurality of post openings located along a second side of the post enclosure.

4. The system, according to claim 1, wherein each of the plurality of modular panel assemblies further comprises:
a plurality of panel sides;
a plurality of fastener openings located along a length of each of the plurality of panel sides;
a panel front connected to each of the plurality of panel sides;
a panel radius located between the panel front and each of the plurality of panel sides;
a plurality of panel side extensions, wherein each of the plurality of panel side extensions is connected to the each of the plurality of panel sides;
a plurality of panel sides continuous attachment bars, wherein each of the plurality of panel sides continuous attachment bars are located adjacent to each of the plurality of panel side extensions; and
a plurality of panel side fasteners openings located along a length of the panel sides continuous attachment bar.

5. The system, according to claim 1, wherein the multi-point lock assembly further comprises:
a sliding bar;
a plurality of bar sections located along a length of the sliding bar;
a plurality of interlocking teeth, wherein each of the plurality of bar sections includes at least one of the plurality of interlocking teeth; and
a plurality of bar openings, wherein at least one of the plurality of interlocking teeth is located within each of the plurality of bar openings.

6. The system, according to claim 1, wherein the hinge cover assembly further comprises:
a hinge cover;
a hinge cover radius located along a length of the hinge cover;
a plurality of hinge cover plates, wherein each of the plurality of hinge cover plates is located on each end to the hinge cover;
a hinge opening located on each of the plurality of hinge cover plates; and
a threaded opening located on each of the plurality of hinge cover plates.

7. The system, according to claim 6, wherein the concealed hinge assembly further comprises:
a plurality of hinge sections;
a hinge section connector located between each of the plurality of hinge sections; and
a plurality of hinge bearings, wherein each of the plurality of hinge bearings is located on one end of each of the plurality of hinge section connectors, wherein the hinge opening is configured to retain the concealed hinge assembly.

8. A method of constructing an equipment security enclosure system, comprising:
providing a first plate assembly;
providing a plurality of post assemblies, wherein each of the plurality of post assemblies includes a first end and a second end, and wherein the first end of each of the plurality of post assemblies is connected to the first plate assembly;
attaching a plurality of modular panel assemblies to the plurality of post assemblies with continuous attachment bars, and wherein a first portion of the plurality of the modular panel assemblies is connected to the first plate assembly;
providing a multi-point lock assembly, wherein the multi-point lock assembly is connected to a second portion of the plurality of modular panel assemblies;
attaching a hinge cover assembly to a third portion of the modular panel assemblies, wherein the hinge cover assembly is located a predetermined distance away from the multi-point lock assembly;
locating a concealed hinge assembly within the hinge cover assembly; and
attaching a second plate assembly to the second end of each of the plurality of post assemblies, and wherein a fourth portion of the plurality of the modular panel assemblies are connected to the second plate assembly.

9. The method, according to claim 8, wherein the method further comprises:
providing a decorative enclosure, wherein the decorative enclosure is configured to cover the equipment security enclosure system, wherein the decorative enclosure is configured to create a flush exterior surface that cannot be gripped by a hydraulic rescue equipment, and wherein the decorative enclosure comprises;
a plurality of upper panels,
an upper panel frame under the plurality of upper panels,
a rear door located adjacent to the upper panel frame,
a plurality of door frame sides located adjacent to the upper panel frame,
a side door frame top located adjacent to two of the plurality of door frame sides,
at least one side door located adjacent to the side door frame top;
a front panel having opening, wherein the front panel is located adjacent to the at least one side door, and
a rear door frame top located adjacent to the rear door.

10. The method, according to claim 8, wherein each of the plurality of post assemblies further comprises:
a post enclosure;
an interior post located within the post enclosure;
a post slot located along a first side of the post enclosure; and
a plurality of post openings located along a second side of the post enclosure.

11. The method, according to claim 8, wherein each of the plurality of modular panel assemblies further comprises:
a plurality of panel sides;
a plurality of fastener openings located along a length of each of the plurality of panel sides;
a panel front connected to each of the plurality of panel sides;
a panel radius located between the panel front and each of the plurality of panel sides;
a plurality of panel side extensions, wherein each of the plurality of panel side extensions is connected to the each of the plurality of panel sides;
a plurality of panel sides continuous attachment bars, wherein each of the plurality of panel sides continuous attachment bars are located adjacent to each of the plurality of panel side extensions; and
a plurality of panel side fasteners openings located along a length of the panel sides continuous attachment bar.

12. The method, according to claim 8, wherein the multi-point lock assembly further comprises:
a sliding bar;
a plurality of bar sections located along a length of the sliding bar;
a plurality of interlocking teeth, wherein each of the plurality of bar sections includes at least one of the plurality of interlocking teeth; and
a plurality of bar openings, wherein at least one of the plurality of interlocking teeth is located within each of the plurality of bar openings.

13. The method, according to claim 8, wherein the hinge cover assembly further comprises:
a hinge cover;
a hinge cover radius located along a length of the hinge cover;
a plurality of hinge cover plates, wherein each of the plurality of hinge cover plates is located on each end to the hinge cover;
a hinge opening located on each of the plurality of hinge cover plates; and
a threaded opening located on each of the plurality of hinge cover plates.

14. The method, according to claim 13, wherein the concealed hinge assembly further comprises:
a plurality of hinge sections;
a hinge section connector located between each of the plurality of hinge sections; and
a plurality of hinge bearings, wherein each of the plurality of hinge bearings is located on one end of each of the plurality of hinge section connectors, wherein the hinge opening is configured to retain the concealed hinge assembly.

15. An equipment security enclosure system, comprising:
a first plate assembly;
a plurality of post assemblies, wherein each of the plurality of post assemblies includes a first end and a second end, and wherein the first end of each of the plurality of post assemblies is connected to the first plate assembly;
a plurality of modular panel assemblies connected to the plurality of post assemblies with continuous attachment bars, and wherein a first portion of the plurality of the modular panel assemblies is connected to the first plate assembly;
a multi-point lock assembly connected to a second portion of the plurality of modular panel assemblies;
a hinge cover assembly connected to a third portion of the modular panel assemblies, wherein the hinge cover assembly is located a predetermined distance away from the multi-point lock assembly;
a concealed hinge assembly located within the hinge cover assembly;
a second plate assembly connected to the second end of each of the plurality of post assemblies, and wherein a fourth portion of the plurality of the modular panel assemblies are connected to the second plate assembly; and
a decorative enclosure, wherein the decorative enclosure is configured to cover the equipment security enclosure system, wherein the decorative enclosure is configured to create a flush exterior surface that cannot be gripped by a hydraulic rescue equipment, and wherein the decorative enclosure comprises;
a plurality of upper panels,
an upper panel frame under the plurality of upper panels,
a rear door located adjacent to the upper panel frame,
a plurality of door frame sides located adjacent to the upper panel frame,
a side door frame top located adjacent to two of the plurality of door frame sides,
at least one side door located adjacent to the side door frame top;
a front panel having opening, wherein the front panel is located adjacent to the at least one side door, and
a rear door frame top located adjacent to the rear door.

16. The system, according to claim 15, wherein each of the plurality of post assemblies further comprises:
a post enclosure;
an interior post located within the post enclosure;
a post slot located along a first side of the post enclosure; and
a plurality of post openings located along a second side of the post enclosure.

17. The system, according to claim 15, wherein each of the plurality of modular panel assemblies further comprises:
a plurality of panel sides;
a plurality of fastener openings located along a length of each of the plurality of panel sides;
a panel front connected to each of the plurality of panel sides;
a panel radius located between the panel front and each of the plurality of panel sides;
a plurality of panel side extensions, wherein each of the plurality of panel side extensions is connected to the each of the plurality of panel sides;
a plurality of panel sides continuous attachment bars, wherein each of the plurality of panel sides continuous attachment bars are located adjacent to each of the plurality of panel side extensions; and
a plurality of panel side fasteners openings located along a length of the panel sides continuous attachment bar.

18. The system, according to claim 15, wherein the multi-point lock assembly further comprises:
a sliding bar;
a plurality of bar sections located along a length of the sliding bar;
a plurality of interlocking teeth, wherein each of the plurality of bar sections includes at least one of the plurality of interlocking teeth; and
a plurality of bar openings, wherein at least one of the plurality of interlocking teeth is located within each of the plurality of bar openings.

19. The system, according to claim 15, wherein the hinge cover assembly further comprises:
a hinge cover;
a hinge cover radius located along a length of the hinge cover;
a plurality of hinge cover plates, wherein each of the plurality of hinge cover plates is located on each end to the hinge cover;
a hinge opening located on each of the plurality of hinge cover plates; and
a threaded opening located on each of the plurality of hinge cover plates.

20. The system, according to claim 19, wherein the concealed hinge assembly further comprises:
a plurality of hinge sections;
a hinge section connector located between each of the plurality of hinge sections; and
a plurality of hinge bearings, wherein each of the plurality of hinge bearings is located on one end of each of the plurality of hinge section connectors, wherein the hinge opening is configured to retain the concealed hinge assembly.
